(19) United States
(12) Patent Application Publication
(10) Pub. No.: US 2005/0204012 A1
(43) Pub. Date: Sep. 15, 2005

(54) Preventing acceptance of undesired electronic messages (spam)

(76) Inventor: Douglas Collin Campbell, Culver City, CA (US)

Correspondence Address: DOUGLAS COLLIN CAMPBELL, 4156 LAFAYETTE PLACE, CULVER CITY, CA, 90232-2818, US

(21) Appl. No.: 11/078,634

(22) Filed: Mar. 11, 2005

Related U.S. Application Data
(60) Provisional application No. 60/552,993, filed on Mar. 11, 2004.

(51) Int. Cl. G06F 15/16

(52) U.S. Cl. 709/206

(57) ABSTRACT

Disclosed is a system and method for utilizing fault tolerant features of a message delivery protocol to prevent acceptance of a message from an unknown sender by a recipient's message server (typically ‘spam’), unless either the recipient or server administrator give explicit permission. When a sender contacts a receiving message server controlled by the disclosed system and requests delivery of a message, the receiving server requests the system to determine whether the message should be accepted for delivery. The system creates one or more identity tuples using the message's envelope information provided by the message server, and uses these to consult databases to determine whether the sender's message should be refused or accepted. If the message is to be refused or accepted, the system instructs the message server appropriately. If the system does not have enough information to determine an action, the system instructs the message server to refuse the message by announcing a temporary delivery failure to the sender's message server. At the same time it transmits the tuple information to an agent for the recipient, which may either make a determination to accept, refuse, or store the message's tuples for examination at leisure by the intended recipient. The recipient can then determine the action to be taken the next time that message and, optionally, future messages from the same source are presented for the recipient. The undelivered message resides on the sender's server per the fault tolerant features of the underlying message protocol, thus minimizing resource use by the receiver until an action is determined. The message is never accepted by the recipient's message server without the recipient's permission, thus preventing the sender of the ‘spam’ from profiting from acceptance of the message or harassing the recipient.

This application claims the benefit of U.S provisional application No. 60/552,993, filed by Douglas Campbell on Mar. 11, 2004.

### BACKGROUND OF THE INVENTION

1. Field of the Invention

The present invention relates to electronic store-and-forward messaging such as e-mail or cell phone text messages, where the underlying messaging protocol has fault tolerant features designed to prevent failures in the delivery of messages.

2. State of the Art

The transmission of undesired electronic messages (spam) is a problem for both recipients and their Internet Service Providers (ISPs) due to the lax source identity standards of common messaging protocols such as the Simple Mail Transfer Protocol outlined in Internet RFCs 0821 and 2821. The intended recipients expend time and energy locating and deleting spam from their inboxes, and the ISPs expend system resources accepting and storing spam until it can be deleted by their users. The result has been the rise of a counter-industry which offers products designed to thwart the effects of spamming; this counter-industry is valued in the millions of dollars.

Senders of spam (spammers) profit from their behavior; if they did not, they would not spam. Their costs of business are low because they utilize stolen processor, disk, and network resources from millions of hacked home computers or “throw away” free e-mail accounts; hence their prices are attractive enough to attract customers who cannot afford more socially acceptable means of advertising. Spammers are commonly paid by the delivered message; a client will pay to have one million messages advertising his product delivered, and the spammer must take the time and effort to effect delivery of one million messages before he/she is paid in full. Most spammers count delivery as occurring when the message is accepted for delivery by the recipient's message server; a rare few count deliveries as occurring when the recipient opens the message, thus causing a request to a web server owned by the spammer for a uniquely named image referenced by the message. To assure the maximum possible success rate, spammers maintain lists of addresses recently harvested from websites, newsgroups, and “ident” servers, essentially by using the techniques outlined in U.S. Pat. No. 6,381,592 to Reuning (2002); a brisk spammer sub-business is done in “cleaned address lists” where the majority of addresses are guaranteed to be valid.

With the rise of Internet cell phone portals, the ability for a spammer to send text messages has become possible, because the e-mail address of a cell phone commonly is just the cell phone number prepended to a subdomain of the cell phone vendor; any spammer who knows which 3-digit telephone exchanges are owned by which cell phone companies can spam just by randomly spraying message servers for telephone exchanges with messages. Since text messages are paid for by the recipient, this type of spamming adds up to a visible out-of-pocket expense for targeted recipients.

Spammers currently use methods similar to that outlined in U.S. Pat. No. 6,643,686 to Hall (2003) to obscure their messages to make content matching detection difficult. Some exceed the method outlined in the patent by rearranging the content of each spam message to make them seem unique, adding random phrases in various locations in their messages, and specifying a unique sender identity for each message transmitted. Additionally, they use millions of viral message servers running on hacked computers to obscure the actual source of the messages. Spammers also use message servers that are not configured to prevent unauthorized use; these servers are commonly called open relay.

Current anti-spam methods may be divided into four classes, three of which concern detecting spam on the recipient message server, and the fourth concerns detecting spam on the sending message server. The first class contains those methods which have the receiving server accept the message and then perform further processing, either within the server or within a client message reader, in order to determine whether the message is spam. The second class contains those methods which prevent messages classified as spam from being accepted by the receiving server. The third class contains those methods which rely on remote sensors to detect and blacklist servers emitting spam. The fourth class, unlike the previous three, attempts to limit the emission of spam onto the network by local senders; because the present invention is designed to limit reception of spam rather than emission, this class is not further considered.

All methods in the first class mentioned above have a disadvantage which allows the spammer to claim credit for a successful message transmission, because the message is accepted even though it is later quarantined or destroyed. This class includes both content-detecting components and pattern-detecting components operating on the entire message content, as well as challenge-response overlay protocols. Content detection filters have additional problems which render them suboptimal; consider the difference between a doctor who professionally receives messages dealing with a medication commonly advertised via spam and who is also targeted by spam advertising the same medication. A similar problem occurs with Bayesian filtering; the doctor's correspondence may well end in the spam folder because of its similarities to things about which the general population is spammed. Due to the possibility of false positives, the present invention does not perform content filtering of the message. Challenge-response protocol overlays such as that outlined in U.S. Pat. No. 6,546,416 to Kirsch (2003) are also suboptimal—they allow for the possibility of two types of ‘Joe job’ (see http://www.everything2.com/index.pl?node=Joe%20Job)—one in which a spammer sends millions of e-mails to a challenge-response server specifying a target third party e-mail address. If the e-mail address belongs to a non-challenge-response server, the target user merely winds up with millions of challenge-response requests in his or her inbox. If, however, the e-mail address belongs to a challenge-response server, the spammer has just induced an internecene war in which, in response to millions of challenge e-mails, the second challenge-response server performs its own round of challenges against the original server. Additionally, challenge-response protocols act to place a weight on the sender which may be too onerous in casual message communications; consider the case where a potential but unknown client sends a request for product information to a salesman—if the salesman's message server requires a challenge-response transaction from the client, the client may go elsewhere. Also in this class are preprocessing appliances like the one outlined in U.S. Pat. No. 6,650,690 to Becker, et al. (2003), which acts as a proxy message server, accepting and quarantining mail before it reaches the actual message server being proxied. Such preprocessing appliances have the defect mentioned previously, in that the spammer can claim victory to his client if his spam is accepted for delivery, even if that acceptance was by a proxy server which later quarantines it. The present invention does not perform any of the actions performed by this class of anti-spam invention, because, in order to do so, it would have to accept the spam.

The second class contains the present invention. The invention closest to the present invention is a non-patented public one called ‘greylisting’ (see http://projects.puremagic.com/greylisting/whitepaper.html), whereby a sending message server must either be whitelisted or prove that it is fault tolerant before its messages are accepted. Prior to proving this, a message identity along with a timestamp is placed in a ‘greylist’. After the sending server has proved fault tolerance by attempting delivery after expiry of the timeout period, its messages are accepted. The method has the advantage of requiring no human intervention to operate—all messages sent from fault tolerant servers will eventually reach a recipient protected by a greylisting system. The defective behavior of greylisting is that it allows a fault tolerant spamming message server to deliver messages to recipients guarded by the greylisting system. The present invention does not have the drawback of ‘greylisting’—it implements a form of ‘greylist’ to hold the message connection and envelope information, but differs by never allowing delivery of a message from an unknown source until the recipient has reviewed collected information and explicitly allowed the message.

The third class requires a sensor array to detect spam; when a server is detected by the sensor array to be emitting spam, the address of the server is placed into a blacklist which is communicated to all recipient servers on the network which subscribe to the blacklist. Blacklists of this type consist solely of server identifiers; no sender identification is used for the reason that it is one piece of data most often falsified by the spammer. Several methods of creating a sensor array exist. One kind of sensor array is a set of human beings who receive spam and then nominate sending servers for inclusion in the blacklist. Another, as described in U.S. Pat. No. 6,052,709 to Paul (2000) is to seed newsgroups and web sites with many fake ‘honeypot’ recipient identifiers in such a context that any server sending to a small group of such identifiers is ipso-facto a spamming message server. The defect associated with blacklist servers is that a certain amount of spam must be transmitted by a spamming message server to real recipients before it is detected and blacklisted, and, for ‘honeypot’ servers, the number of real recipients impacted are in direct ratio to the ratio of fake to real recipient identifiers available to the spammers. In addition, if a spamming message server happens also to be a bona-fide server emitting non-spam messages, those too will be stopped by the blacklist servers. The present invention does implement a per-recipient blacklist, but the way in which additions are made to this list is for the recipient to transfer the necessary data from the greylist, thus avoiding the defects associated with blacklist servers which obtain their data from sources other than the immediate user.

### SUMMARY OF THE INVENTION

Therefore, an objective of the invention is to never permit a message to reach the recipient's inbox whose connection and envelope information has not been explicitly approved by recipient.

Another objective of the invention is to minimize the use of receiver-side resources in handling spam by forcing an unsolicited message to reside within sender-side resources until the recipient determines to accept the message

Another objective of the invention is to allow messages from senders authorized by the recipient to be immediately accepted.

Another objective of the invention is to allow messages from senders unwanted by the recipient to be immediately refused.

Another objective of the invention is to prevent denial of service attacks using any feature of the invention.

Another objective of the invention is to allow inputs and outputs associated with decisions made by the invention to be logged for analysis.

Another objective of the invention is to allow the recipient to accept or reject message delivery based on any combination of the following information: sender identifier, sending server's address, sending server's name obtained by trusted means, sending server's nickname obtained from a message protocol step, digest of message subject.

Another objective of the invention is to allow the recipient to accept or reject message delivery based on wild-carded forms of the aforementioned information.

Another objective of the invention is to allow the recipient to reject messages where any of the above information is missing.

Another objective of the invention is to allow a recipient to do nothing with regard to a message. In that case, the message is neither accepted nor permanently rejected by the recipient's server.

Another objective of the invention is to allow a recipient to specify a timeout before a message delivery attempt is reported to the recipient or an agent for action.

Another objective of the invention is to allow a recipient to specify the periodicity of requests made to the recipient for action.

Another objective of the invention is to allow a recipient to change or retract previous actions.

Another objective of the invention is to report a message delivery attempt from an unknown sender to the recipient or an agent for action.

Another objective of the invention is to protect the privacy of each recipient by not revealing to multiple recipients of any given message the identity of any other recipient except through information which would be delivered to the recipient in the absence of the existence of the invention.

Another objective of the invention is to allow a single instance of the invention to control one or more message servers.

A still further objective of the invention is to curtail attempts at denial of service by enemy servers.

These objectives are realized in the present invention. In a particular embodiment, the invention would operate via a network attachment to both a database server and a set of protected SMTP servers. The database server would persistently store the various elements of each recipient's profile, keyed by the recipient identifier. The database server also would store a system level list of trusted and enemy servers. For each connection attempt by another SMTP server to a protected SMTP server, the protected server would report the connection information to the invention and the invention would then determine via consultation with the database server whether and for which of the recipients message reception ought to continue. If the decision could not be made with the connection information, the invention would instruct the mail server to provide it with envelope information, which would be packaged with the connection information and added to the greylist database tables associated with each recipient; the e-mail would then be temporarily failed. At the periodic intervals specified for each user, the invention would inform them via an e-mail concerning any pending decisions they must make. The users, at their leisure, could invoke an interface which provides the necessary tools to allow new decisions to be made and existing decisions reviewed and modified.

### BRIEF DESCRIPTION OF THE DRAWINGS

FIG. 1 is a network diagram describing the interrelationships between the invention and other interesting components of the internet on which it resides.

### DETAILED DESCRIPTION

The description of the preferred embodiments of the invention is based on the fault tolerant Simple Mail Transport Protocol, Internet RFC 0821/2821 by J. Klensin; the description of this protocol is available at http://www.fags.org/rfcs/rfc2821.html. A person skilled in the art will see that this description may be translated to any fault tolerant message delivery system, and that the invention may be attached to message servers on networks other than the Internet. A person skilled in the art will also readily appreciate the various ways in which the invention can be implemented, from a network appliance to a software module incorporated directly into the message servers it controls. In the preferred embodiment discussed herein, the invention is depicted in the context of a message server implementing the SMTP protocol, with the invention implemented as a network appliance.

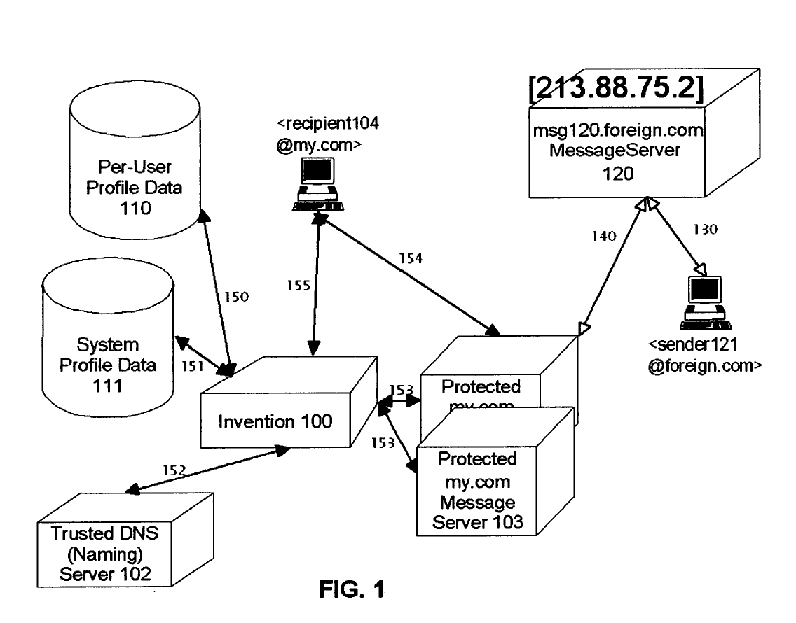

FIG. 1 illustrates this preferred embodiment. In addition, FIG. 1. provides a set of example information to form the basis for discussion of the operation of the invention.

During the initial connection phase of any message protocol (including SMTP), the source location must offer a valid address representing itself to the receiving message server, or the communication session cannot continue. In FIG. 1, this constitutes the establishment of Link 140 with the sending server offering its IP address of [213.88.75.2]. The invention is then contacted via Link 153 and is told this IP address along with a session identifier by the protected server. It immediately determines whether the IP address is blacklisted in the system profile either by unique specification or range via a query on System Profile Data 111 via Link 151; if it is, the invention informs the message server to immediately terminate Link 140. If the IP address is not blacklisted, it is reverse-resolved using Trusted DNS Naming Server 102 via Link 152 to obtain a trusted name for the sending server. If no name is available, that fact is recorded for future use; if a name is available, the System profile data is checked to see if that name, or any of its subdomains are white or black listed. In the example in FIG. 1, the foreign messageserver 120's full name is msg120.foreign.com; its subdomains are .foreign.com and .com. Hence, the invention first checks to see if ‘msg120.foreign.com’ is blacklisted or whitelisted; if not, then it checks ‘.foreign.com’, and finally ‘.com’. The moment the invention obtains an indication of white or black listing, it stops searching and acts upon the information by either informing the Server 103 to terminate Link 140 or to accept the message. If no white or black list entry was found, the Server 103 is instructed to continue as it would have prior to incorporation of the invention. The Invention 100 updates the session information with its discoveries and optionally logs its behavior.

In the SMTP message protocol (but not necessarily others) a secondary identification step occurs. A command called HELO/EHLO is executed by the Server 120 to offer its nickname to Server 103 via established Link 140; Server 103 then tells the nickname to Invention 100, which then attempts to use Server 102 to resolve the name to an IP address. If the name resolves to an IP address identical to that used to establish Link 140, and the nickname offered is not identical to the name operated on in the paragraph immediately above, it and its subdomains are also checked by Invention 100 against the database 111 with similar semantics. If the name is not found in the white or black lists, it is also recorded for later use on a per-user basis.

After the HELO transaction, the Server 120 then provides a sender identifier (with SMTP, this is done by transmitting “MAIL FROM: <senders121@foreign.com>“as a command to Server 103. Server 103 then tells Invention 100 what the claimed sender identity is, and Invention 100 stores that into the session information it is keeping. No action can be performed on this name until one or more recipient identities have also been transmitted by Server 120 via Link 140 to Server 103. The Server 103 responds with an OK indication to Server 120, allowing the next phase of the protocol to proceed.

Server 120 then provides a list of one or more recipient identifiers by transmitting one or more “RCPT TO: <recipient>” commands to Server 103. In our example, exactly one is transmitted, a “RCPT TO: <recipient104@my.com>” . Each RCPT TO command by Server 120 causes Server 103 to inform Invention 100 of the recipient id. At this point, Invention 100 has four 2-tuples describing the current connection: they are
(<sender121@foreign.com>,[213.88.75.2]),
(<sender121@foreign.com>,msg120.foreign.com),
(<sender121@foreign.com>,.foreign.com), and
(<sender121@foreign.com>,.com).

A search in the that order is made in <recipient104@my.com>'s Profile Data 110 database to see if any of the connection descriptions are contained in the database. If the connection is whitelisted, the Server 120 is told to accept the message unconditionally for recipient 104 only; if blacklisted, the Server 120 is told to reject the message permanently for recipient 104 only. If the message is neither whitelisted nor blacklisted, that indicates that this sender/server pair has never been seen before. If that is the case, the Invention 100 makes or updates a greylist entry in recipient 104's Profile Data 110 database indicating the latest time this sender attempted communication, and incrementing the count of access attempts. It updates its private session information indicating that this is a greylisted session for recipient 104. However, for SMTP, Invention 100 instructs the Server 103 to continue allowing Server 120 to send data. If no equivalent to the header information in the SMTP ‘DATA’ command below is sent, the Invention 100 should temporarily fail reception of the message for recipient 104.

The next material sent by Server 120 is a ‘DATA’ command stating that the actual message information is about to follow. The message information under SMTP is divided into message headers and a message body. If message headers are present, one important one is the Subject header, whose use is to provide a brief description of the body of the message. In the preferred implementation of the invention, the invention stores a truncated version of the Subject; the truncation (at a system or user defined length) is done so that attempts by a spammer to send their entire message in the Subject field will fail. Each message header is sent by the Server 103 to Invention 100 as they are received; when the Invention 100 obtains the Subject information, it updates the appropriate greylist entry (if any) contained in recipient 104's Per-User Data 111 with the truncated Subject. If the session indicated that greylisting was occurring for recipient 104, the Invention 100 indicates to the Server 103 that it should temporarily fail the reception of the message for recipient 104. If no Subject header is transmitted, the Invention indicates upon an indication by Server 103 that the last header for this message has been transmitted to the Server 103 that Server 103 should temporarily fail reception of the message for recipient 104.

Note that in SMTP the body of the message is the last item transmitted. Under SMTP, the Message Server 103 is able to terminate the transmission of the message and destroy the Link 140 before the body is transmitted, provided all recipients have either blacklisted or greylisted the message. Hence, the body is only accepted if one of its recipients desired it.

Periodically, Invention 100 will scan the Per User Profile Data 110 looking for greylist entries for each user. If a user has greylisting entries, and the user has not previously been notified of them, information about them is aggregated by the Invention 100 and sent as a single e-mail or other type of alert to the user. The user can then directly instruct the Invention 100 as to the disposition of the greylist entries—leave them alone, delete them, convert them into whitelist entries, or convert them into blacklist entries. If the user chooses to leave sender 121's entries alone, as they reach a predetermined age, the Invention 100 deletes them from the Per User store 110. At that point the sender 121 is back at the beginning; the next message from him/her to recipient 104 will restart the process outlined above. If recipient 104 deletes all the entries, the same thing occurs. If recipient 104 converts them to whitelist entries, Server 120's next fault tolerant retry on behalf of sender 121 will reach recipient 104. If recipient 104 converts them to blacklist entries, Server 120's next fault tolerant retry on behalf of sender 120 will be permanently rejected, as will any further attempts by sender 120 to communicate with recipient 104.

Administrator 106 is allowed to update the System Profile Data 111.

Administrator 106 is able to state servers for which all traffic is permitted via a whitelist, and to ban servers via a blacklist. In the case that a server's identity, either as an IP address or as a trusted name, is present in the System Profile Data 111 on either list, no per-user processing occurs by Invention 100. This allows an administrative bypass of per-user preferences; such action might be needed if, for example, Administrator 106 determines that foreign.com Server 120 is participating in denial of service attacks upon Server 103.

### REFERENCES

Arieh, http://www.everything2.com/index.pl?node=Joe%20Job, Aug. 19, 2002

Evan Harris, “The Next Step in the Spam Control War: Greylisting”, http://projects.puremagic.com/greylisting/whitepaper.html, printed Mar. 8, 2005

Jonathan B. Postel, “RFC 821: Simple Mail Transfer Protocol”, http://www.fags.org/rfcs/rfc821.html, August 1982

J. Klensin, “RFC 2821: Simple Mail Transfer Protocol”, http://www.fags.org/rfcs/rfc2821 .html, April 2001

U.S. Pat. No. 6,643,686 to Hall (2003)

U.S. Pat. No. 6,381,592 to Reuning (2002)

U.S. Pat. No. 6,546,416 to Kirsch (2003)

U.S. Pat. No. 6,650,690 to Becker, et al. (2003)

U.S. Pat. No. 6,052,709 to Paul (2000)

1. A method and system for controlling one or more associated fault tolerant message servers, said method and system comprising:
(a) providing a per-user persistent memory used to store user instructions to cause permanent rejection of messages sent to an associated message system from a given sender at a given location specified by server name, subdomain name, or address, or from a given sender without an address, or from a given address without a sender
(b) providing a per-user persistent memory used to store user instructions to cause acceptance of messages sent to an associated message system from a given sender at a given location specified by server name, subdomain name, or address, or from a given sender without an address, or from a given address without a sender
(c) providing a per-user persistent memory used to store information about a sender identity and location specified by server names, subdomain names, and address which has attempted to send a message to an associated message system, but whose information is present in none of the associated memories described in (a) and (b)
(d) providing a system persistent memory used to store administrator instructions as to whether messages sent to the enclosing fault tolerant message system from a given location specified by server name, subdomain name, or address shall always be rejected regardless of the intended recipient
(e) providing a system persistent memory used to store administrator instructions as to whether messages sent to the enclosing fault tolerant message system from a given location specified by server name, subdomain name, or address shall always be accepted regardless of the intended recipient
(f) providing a means for a user to display the content of the memories described in (a) (b) and (c) associated with the user
(g) providing a means of periodically alerting a user when the contents of their associated memory (c) is nonempty or has changed
(h) Providing a means of periodically clearing un-processed aged entries from all user memories of type (c)
(i) providing a means for a user to translate an instruction from the memory described in (c) associated with that user to either of the memories described in (a) or (b) associated with the user, afterward removing the predecessor instruction in (c)
(j) providing a means for a user to translate an instruction from the memory described in (a) associated with that user to the memory described in (b) associated with that user, afterward removing the predecessor instruction in (a)
(k) providing a means for a user to translate an instruction from the memory described in (b) to associated with that user to the memory described in (a) associated with that user, afterward removing the predecessor instruction in (b)
(l) providing a means for a user to remove an instruction from any of the three memories described in (a), (b), and (c) associated with that user without translating it to another of the memories
(m) providing a means for an administrator or agent to add or delete entries in the memories described in (d) and (e)
(n) providing a means for an administrator or agent to move entries between the memories described in (d) and (e)
(o) providing a means for an administrator or agent to destroy the memories described in (a), (b), and (c) associated with a particular user
(p) Providing a means for an administrator or agent to create and initialize the memories described in (a), (b), and (c) associated with a particular user
(q) providing a means to instruct an associated fault tolerant message server to accept a message for one or more given users out of the group for which the message is intended when the users have all instructed so via an instruction contained in their respective memories (b)
(r) providing a means to instruct an associated fault tolerant message server to reject a message for one or more given users out of the group of users for which the message is intended when the users have all instructed so via an instruction contained in their memory (a)
(s) providing a means to instruct a fault tolerant message server to temporarily reject delivery of a message for one or more given users out of the group for which the message is intended when that user has no instructions in either of the associated memories (a) or (b)
(t) providing a means, when a message delivery is attempted to a plurality of users having differing instructions in their associated memories, for some users to accept the message, others to reject it, and still others to have had no instructions relating to it, and to act accordingly in each case as described in (q), (r), and (s) above
(u) providing a means to instruct an associated message server to reject all messages associated with a given session per an instruction contained in the memory (d)
(v) providing a means to instruct an associated message server to accept all messages associated with a given session per an instruction contained in the memory (e)
(w) providing a means to obtain a unique session identifier from an associated message server when another message server connects to it in order to deliver a message
(x) providing a means to obtain the address of the sending message server from an associated message server, with information relating it to the appropriate session
(y) providing a means to query a trusted naming server for a server name given its address
(z) providing a means to query a trusted naming server for a server address given its name
(aa) providing a means to obtain the nickname provided by a sending message server to an associated message server, with information relating it to the appropriate session
(bb) providing a means to determine whether the provided nickname matches the server address also provided within the same session
(cc) providing a means to obtain the sender identity associated with a session from the associated message server hosting the session
(dd) providing a means to obtain the list of recipient identities associated with a session from the associated message server hosting the session
(ee) providing a means of properly tracking a plurality of simultaneous sessions
(ff) providing a means to implement an administrator's will as expressed in the associated memories described in (d) and (e), over and above any individual user's will
(gg) providing a means to add one or more instructions to a user's associated memory as described in (c) whenever an message addressed to that recipient is received and the user does not have instructions associated with the message context contained in the user's associated memories (a) and (b)
(hh) providing a means to ignore invalid recipients contained in the recipient list
(ii) providing a means to permanently reject a message which only has invalid recipients contained in the recipient list
whereby said system permanently rejects a message sent to a user if the sender and sending server information match any instruction stored in the associated memory defined in (a) above, and
whereby said system accepts a message sent to a user if the sender and sending server information match any instruction stored in the associated memory defined in (b) above, and
whereby said system temporarily rejects a message sent to a user and stores sender and sending server information in the associated memory defined in (c) if the sender and sending server information are not present in the associated memory defined in either (a) or (b) above, and
whereby said system allows an administrator to override the decisions of users so as to prevent denial of service attacks and proper transmission of system alerts by instructions stored in the memories as defined in (d) and (e) above.

2. The system and method of claim 1, wherein additional information is added to the persistent tables specified in (a), (b), or (c) to make the reason for an instruction easier for the user to interpret.
